(19) United States
(12) Patent Application Publication
(10) Pub. No.: US 2014/0176611 A1
(43) Pub. Date: Jun. 26, 2014

(54) IMAGE DISPLAY SYSTEM AND METHOD FOR DISPLAYING IMAGE

(71) Applicant: ASUSTeK COMPUTER INC., TAIPEI (TW)

(72) Inventors: Liang-Chung HUANG, TAIPEI (TW); Chien-Yao CHANG, TAIPEI (TW)

(73) Assignee: ASUSTeK COMPUTER INC., TAIPEI (TW)

(21) Appl. No.: 14/106,842

(22) Filed: Dec. 15, 2013

(30) Foreign Application Priority Data
Dec. 25, 2012 (TW) 101149838

(51) Int. Cl. G06T 3/60

(52) U.S. Cl. CPC G06T 3/60
USPC 345/649

(57) ABSTRACT

An image display system and a method for displaying the image are disclosed, in which the image display system includes a display device and a host. The display device includes an acceleration sensor and a microcontroller. The acceleration sensor detects movement of the display device and generates a plurality of inner-integrated circuit packets. The microcontroller transfers the received inner-integrated circuit packets and converts the received inner-integrated circuit packets to the USB packets. The host receives the USB packets and accordingly adjusts the setting of the displayed image.

### CROSS-REFERENCE TO RELATED APPLICATION

This application claims the priority benefit of Taiwan application serial No. 101149838, filled on Dec. 25, 2012. The entirety of the above-mentioned patent application is hereby incorporated by reference herein and made a part of specification.

### BACKGROUND OF THE INVENTION

1. Field of the Invention

The disclosure relates to an image display system, and more particularly, to an image display system including a display device.

2. Description of the Related Art

Nowadays, portable electronic devices, such as a mobile phone, a notebook and a personal digital assistant (PDA), are widely used. These electronic devices are used for searching information, connecting to the web, making phone calls or noting all kinds of information, schedules to meet all kinds of requirements in daily

Users often need to rotate the electronic devices for inputting data or watching pictures shown in the electronic devices more conveniently. For example, when a user uses a camera to take photos, the user adjusts a shooting angle according to a direction, a shape or a position of the subject, by rotating the camera to a specific angle first, and then begins to take photos. For example, when the subject is a tall building, users need to rotate the electronic device vertically to make the height of the image greater than the width. In this way, the whole building can be taken. Therefore, when the user watches a film, if the image of the film is wide, he needs to rotate the electronic device by 90 degrees to watch the film horizontally for a better visual effect.

### BRIEF SUMMARY OF THE INVENTION

An image display system and a method for displaying an image are provided. A universal serial bus (USB) is used for transferring image data to make the image data transferring more effective and convenient and expand the application range of an external display.

The image display system includes a display device and a host. The display device displays an image and the display device includes an acceleration sensor and a microcontroller. The acceleration sensor detects movement of the display device and generates a plurality of inner-integrated circuit packets. The microcontroller transfers the received inner-integrated circuit packets and converts the received inner-integrated circuit packets to the USB packets. The host receives the USB packets from the display device and adjusts a displaying setting of the image.

The method for displaying an image applied to an image display system adjusts a displaying setting of the image of a display device. The method for displaying the image comprising following steps: detecting movement of the display device; generating and outputting a plurality of first USB packets with the movement information conforming to the USB standard, transferring the first USB packets to a host; analyzing the first USB packets to obtain movement information and determining a display setting according to the movement information.

### BRIEF DESCRIPTION OF THE DRAWINGS

FIG. 1 is a schematic diagram showing an image display state in a first embodiment;

FIG. 2 is a block diagram showing an image display system in a first embodiment; and

FIG. 3 is a flow chart showing a method for displaying an image in a second embodiment.

### DETAILED DESCRIPTION OF THE EMBODIMENTS

An image display system and a method for displaying an image use a universal serial bus (USB) to transfer image data.

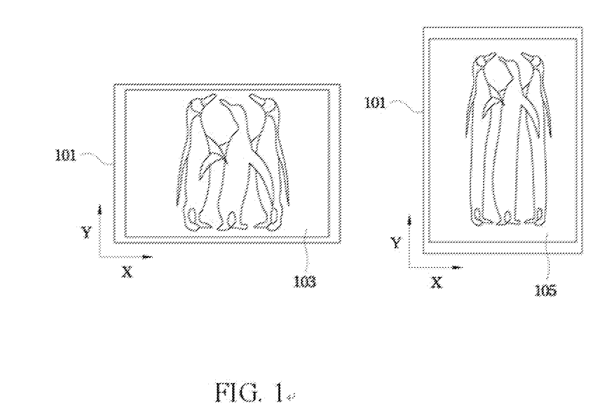

FIG. 1 is a schematic diagram showing an image display state in a first embodiment. In FIG. 1, when an electronic device 101 is placed horizontally, a picture 103 of the electronic device 101 is displayed by horizontal type. When the electronic device 101 rotates by 90 degrees (in clockwise or counterclockwise), which means the electronic device is laid vertically, the picture 105 of the electronic device 101 is displayed by straight type.

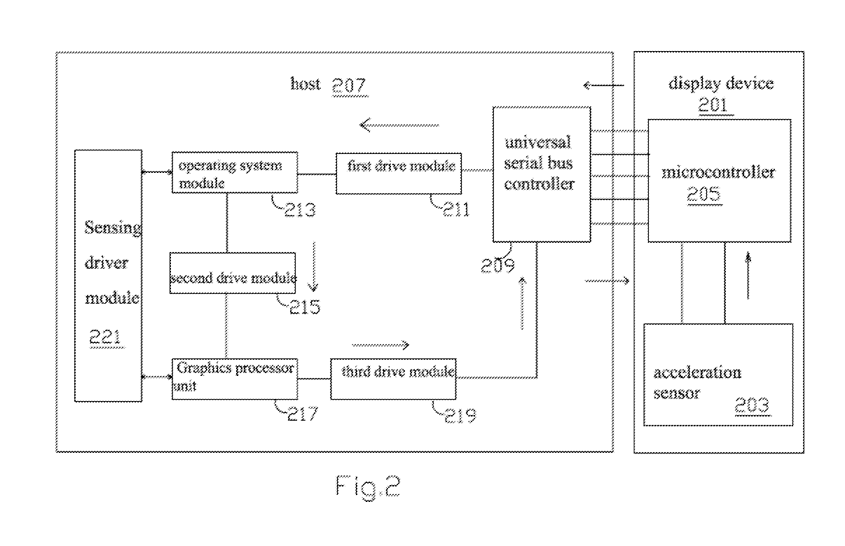

FIG. 2 is a block diagram showing an image display system in a first embodiment. The image display system 200 can adjust a display setting of the image. The display setting includes displaying an image horizontally or vertically, adjusting an image proportion and adding an interlude effect when the image is rotated, which is not limited herein.

The image display system 200 includes a display device 201 for displaying an image and a host 207.

The display device 201 includes an acceleration sensor 203, such as a G-Sensor and a microcontroller 205, and the display device 201 transfers and receives an image signal via a USB. The acceleration sensor 203 detects movement information of the display device 201 and the movement information is transferred to the microcontroller 205 via an inner-integrated circuit. The microcontroller 205 converts the received movement information of the display device 201 to USB packets. The microcontroller 205 can convert the inner-integrated circuit packets to the USB packets, or convert the USB packets to the inner-integrated circuit packets, and transfer or receive the USB packets.

The host 207 further includes a USB controller 209, a first drive module 211, an operating system module 213, a second drive module 215, a graphic processing unit (GPU) 217, a third drive module 219, and a sensing drive module 221.

The host 207 receives image data from the display device 201 and adjusts a display setting of the image, such as displaying horizontally or vertically, which is not limited herein.

The display device 201 uses the acceleration sensor 203 to detect the movement information and then the microcontroller 205 converts the movement information to USB packets which conform to the USB standard and transfers the USB packets to the USB controller 209 of the host 207.

The USB controller 209 is an USB interface for receiving and transferring USB packets. The first drive module 211 analyzes these USB packets and obtains analyzed data. This is, the first drive module 211 can analyze which packet state the current packet in transferring belongs to, such as token packets, data packets or handshake packets, the transferring data are in, and it also can determine that the packet is a synchronization sequence a packet identifier, a data packet, a cyclic redundancy check (CRC) or an end of page (EOP). The first drive module 211 can correctly capture the movement information of the display device after the data are analyzed.

The operating system module 213 determines a display setting of the image, such as displaying the image horizontally or vertically, according to the movement information analyzed by the first drive module 211, and then generates a plurality of display instructions. The second drive module 215 transfers these instructions to the GPU 217. When the operating system module 213 cannot generate the display instructions meeting the requirements, the second drive module 215 converts the display instructions to appropriate forms. The GPU 217 generates image display information including the display setting according to the display instructions.

The sensing drive module 221 synchronizes commands, assists the operating drive module 213 to process the movement information, and assists the operating system module 213 to operate the GPU 217. When the sensing drive module 221 is boosted, an application program interface is initiate to generate instructions to operate the display device 201 to display images. The third drive module 219 converts the image data to the USB packets.

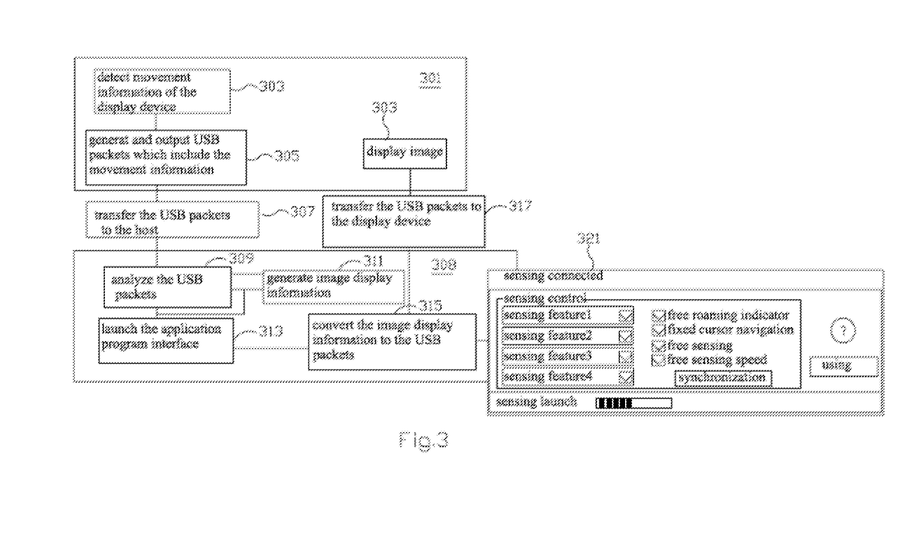

FIG. 3 is a flow chart showing a method for displaying an image in a second embodiment. The method for displaying an image is achieved by software and adjusts the display setting of the image of the display device. The method for displaying an image is divided into two parts which are applied to a display device 301 and a host 308, respectively.

In step 303, the movement information of the display device, such as the placing state of the display device or the rotating angle, is detected. In step 305, a plurality of first USB packets which include the movement information and conform to the USB standard are generated and outputted. The generated movement information in step 303 is a format of the inner-integrated circuit packets. In step 305, the inner-integrated circuit packets are converted to the USB packets. In step 307, the USB packets are transferred to host 308. In step 309, the host 308 analyzes the USB packets after the USB packets are received to obtain the movement information and determines the display setting of the image, such as displaying the image horizontally, vertically, obliquely or rotation at an angle, according to the movement information.

In step 311, image display information is generated according to the display setting, and the generated image display information includes the display setting data. In step 313, the host 308 initiate application program interface to generate image display instructions and provides an operating window 321 for the users to input relevant information and assist generating the display instructions. In step 315, the image display information is converted to second packets conforming to the USB standard. In step 317, transferring the USB packets to display device 301. In step 319, the display device 301 displays image according to the USB packets. Therefor the images can be displayed according to the setting information of direction, such as in horizontal or vertical.

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. Art image display system comprising:
a display device displaying an image, wherein the display device includes:
an acceleration sensor sensing movement information of the display device and generating a plurality of inner-integrated circuit packets; and
a microcontroller converting the received inner-integrated circuit packets to multiple universal serial bus (USB) packets; and
a host electrically connected to the display device, receiving the USB packets and adjusting a displaying setting of the image accordingly.

2. The image display system according to claim 1, wherein the host includes:
an USB controller receiving or transferring the USB packets;
a first drive module analyzing the USB packets to obtain analyzed data;
an operating system module determining the displaying setting of the image according to the analyzed data and generating multiple display instructions; and
a graphics processor unit generating image display information including the displaying setting according to the display instructions.

3. The image display system according to claim 2, wherein the host further includes:
a second drive module transferring the display instructions to the graphics processor.

4. The image display system according to claim 2, wherein the host further includes:
a third drive module converting the image display information to the USB packets.

5. The image display system according to claim 2, wherein the host further includes:
a sensing drive module initiating an application program interface.

6. A method for displaying an image, applied to an image display system to adjust a displaying setting of the image of a display device, the method for displaying the image comprising following steps:
detecting movement information of the display device;
generating and outputting a plurality of first universal serial bus packets which conform to a USB standard and include the movement information;
transferring the first USB packets to a host;
analyzing the first USB packets to obtain the movement information; and
determining a display setting according to the movement information.

7. The method for displaying the image according to claim 6, wherein the method further includes:
generating a plurality of inner-integrated circuit packets according to the movement information; and
converting the inner-integrated circuit packets to the first USB packets.

8. The method for displaying the image according, to claim further includes:
generating image display information according to the display setting and converting the image display information to the second USB packets;
transferring the second USB packets to display device; and
displaying image according to the second USB packets.

9. The method for displaying the image according to claim 8, wherein the image is displayed horizontally or vertically.

10. The method for displaying the image according to claim 8, further includes initiating an application program interface to generate a plurality of image display instructions to operate the display device to display image.
